(19) United States
(12) Patent Application Publication
(10) Pub. No.: US 2006/0119017 A1
(43) Pub. Date: Jun. 8, 2006

(54) Method for making ceramic work piece and cermet work piece

(76) Inventor: Hwa-Hsing Tang, Taipei City (TW)

Correspondence Address: HDSL, 4331 STEVENS BATTLE LANE, FAIRFAX, VA, 22033, US

(21) Appl. No.: 11/000,953

(22) Filed: Dec. 2, 2004

(51) Int. Cl. C03B 29/00; B28B 3/00; B28B 1/00

(52) U.S. Cl. 264/642; 156/89.11

(57) ABSTRACT

Method for making ceramic work piece or cermet work piece is realized by utilizing a multi-layer processing method. Several kinds of materials are mixed to form slurry. Then the slurry is formed into a thin green layer, which will be dried by infrared light, so that the thin green layer will be hardened. Next, the thin green layer exposed under a high-energy beam is sintered to bond together locally due to heat effect at different temperature levels, respectively. After multiple repetitions of this procedure a three-dimensional ceramic part or cermet part can be fabricated layer upon layer. The green portion, which is not scanned by the high-energy beam, can be removed with suitable methods, such as submerged in water or sodium hydroxide water solution, due to disparate characteristics of scanned and unscanned portions. A ceramic part or a cermet part can be rapidly produced in this way.

### BACKGROUND OF THE INVENTION

The present invention relates to a method for making ceramic work pieces and cermet work pieces; more specifically, the present invention provides a method for fabricating three-dimensional (3-D) ceramic work pieces and cermet work pieces by a multi-layer processing method.

Due to its high hardness, ceramic is not easy to be cut, and due to its low conductivity, it is hard to be processed by electrical discharg machining. Moreover, it is also not easy to be connected by welding or by other mechanical means; therefore, its most common manufacturing method is powder metallurgy. However, conventional powder metallurgy for ceramic includes forming a ceramic green part by a mold and post-sintering in a high temperature furnace; not only part's complexity is limited but also its production cost is very high for a small quantity production. Because rapid prototyping does not need mold, can fabricate complex work pieces and can reduce production cost for prototype, it can improve the competitiveness of a manufacturing company and promote the application of ceramic material. The technology of the rapid prototyping for ceramic work piece can be sorted into following five different categories:

1. Stereo Lithography (SL)—U.S. Pat. No. 4,575,330, 1986 to Charles Hull represents this technology, and has been subsequently commercialized by 3D System Inc. Dr. Brady of University of Michigan describes a process based on the Stereo Lithography method that uses ceramic resin (a mixture of ceramic powder and light-sensitive resin) as a raw material and exposes such material under a directed ultra violet light in order to solidify the liquid state resin. This process bonds ceramic powder to form ceramic green part, then removes the binder to increase the density of the ceramic green part with conventional sintering technology.

2. Selective Laser Sintering (SLS)—U.S. Pat. No. 4,863,538, September, 1989 to Deckard, represents this technology, and has been subsequently commercialized by DTM Company. The SLS technology can be applied for various materials to produce 3-D work pieces as long as the material has the form of powder. At present, the SLS technology for ceramic parts comprises the steps of coating ceramic powder with resin, melting the resin with a laser, so that the resin acts as a bonding agent to connect ceramic powder, and then processing the ceramic green part with conventional ceramic sintering technology to obtain the final ceramic work piece.

3. Fused Deposition Modeling (FDM)—Such technology involves heating a raw material strand until it melts, then material strands are extruded to form a 3-D object. Agarwala, professor of Center for Ceramic Research at Rutgers University, has made material strands composed of ceramic powder and organic binder. The material strands are processed to fabricate a ceramic green part by FDM machine; then the ceramic green part formed is sintered by conventional ceramic sintering methods to obtain the final ceramic work piece.

4. Three Dimensional Printing (3DP)—The 3DP technology is represented by Three Dimensional Printing method (U.S. Pat. No. 5,204,055, April 1993, Sachs et al.), which is similar to the ink jet technology in that binding agent is selectively spurted out and onto a designated powder material. Such process starts by laying a thin layer of powder, spurting liquid binder from the nozzle and onto the surface of the powder layer, wherein the powder layer in the affected area will glue together to form a thin cross section. The above steps are repeated until a three-dimensional object is formed. If the major raw material is ceramics, then the above steps will form a solid three-dimensional ceramic green part, and conventional ceramic sintering technology will complete the 3DP process in forming a final, sintered ceramic work piece.

5. Laminated Object Manufacturing (LOM)—U.S. Pat. No. 4,752,353, Feygin, owned by company Hydronetics, describes a technology that utilizes a laser beam to cut a cross section of a 3-D object on a thin slice of material, and then glue these thin slices one on top of another to form a 3-D object. Such a process can be applied on materials including paper and sheet metal. However, in the case of ceramics as the prime constituent material, each ceramic thin slice is pre-fabricated with a mixture of ceramic powder and polymer binder. Each ceramic thin slice corresponding to a cross sectional layer of a 3-D work piece is shaped by a directed laser beam. When all the thin slices corresponding to the cross sections are shaped, a 3-D ceramic green part can be formed by stacking and gluing the entire slices one on top of another. After sintering in a furnace, a final ceramic work piece can be obtained.

The above-mentioned five category technologies are all related to the forming of ceramic green parts using organic binding agents and all require further sintering equipment for final ceramic sintering. There are many drawbacks of those methods, for example, removing binding agents will cause pollution and excessive holes will also be formed on the ceramic work pieces. Hence, improvements are desired.

Another method, High Energy Beam Ceramic Fusion, for rapid forming of a ceramic work piece (U.S. Pat. No. 6,217,816) is disclosed by the inventor. The procedure includes: firstly an inorganic binder and water are put into ceramic powder. They are mixed to form slurry. Then the slurry is formed to be a thin green layer. Preferably, due to the bonding effect of the inorganic binder, this thin green layer will be preheated and dried, so that the thin green layer will be hardened. Owing to heat fusion, the thin green layer selectively exposed under a high-energy beam is sintered to cause ceramic molecules to be bonded together locally. Each thin ceramic layer can be laid and bonded onto the previous layer by the same method. After multiple repetitions of this procedure a three dimensional ceramic part can be fabricated layer upon layer. The green portion, which is not scanned by the high-energy beam, will be removed with suitable methods. By this way a ceramic part can be rapidly produced with a rapid prototyping apparatus, the post sintering is not necessary, the pollution caused by the removal of organic binder can be reduced, and processing time can also be shortened. However, High Energy Beam Ceramic Fusion means that working temperature has to be higher than the melting point of ceramics, such as 1800° C. for silicon dioxide and substantial amount of energy has to be absorbed by the material before reaching such a temperature. Therefore, high power output is required and scanning speed can't be too fast. In addition, the ceramics produced in this way are brittle. To overcome these drawbacks, the present invention is offered.

### SUMMARY OF THE INVENTION

The present invention provides a layered process for making three dimensional ceramic work piece and cermet work piece while the usage of molds can be omitted, and there is almost no limitation as to what shapes the work pieces take. Accelerating manufacturing speed and lowering manufacturing cost can be achieved by applying this technique.

In order to overcome the drawback of the High Energy Beam Ceramic Fusion, one variant of the present invention called High Energy Beam Ceramic Sintering uses relatively low working temperature, and consumes less energy than that of the High Energy Beam Ceramic Fusion.

The High Energy Beam Ceramic-Sintering involves four steps, including:

(1) preparing raw materials,

(2) forming a thin green layer,

(3) scanning the thin green layer with a high-energy beam to sinter it, and

(4) removing unscanned portion of the green layers.

In the above procedure, the third step uses a temperature below the melting point of ceramic powder, so that not all of materials are melted and there is at least one kind of powder maintained in solid state.

In the High Energy Beam Ceramic Sintering, an inorganic binder and a dissolving agent are put into ceramic powder to form slurry. Then the slurry is formed to be a thin green layer, which will be heated by a heater, and the ceramic powder is bonded by the binding agent, so that the thin green layer will be hardened. Next, the thin green layer exposed under a high-energy beam is sintered to bond together locally because of heat effect at a temperature level below melting point of the ceramic which has the highest melting point. After multiple repetitions of this procedure, a three dimensional ceramic part can be fabricated layer upon layer. Due to disparate characteristics of scanned and unscanned portions, the unscanned green portion can be removed with suitable methods, such as submerged in water or sodium hydroxide water solution. A ceramic work piece can be rapidly produced in this way.

The above-mentioned technique can be sorted into two different categories; they are liquid sintering and chemical reaction, as following:

1. Ceramic High Energy Beam Liquid Sintering: one or more than one kind of ceramic powder, an inorganic binder and a dissolving agent (ex. water) are mixed to form slurry. The slurry is formed to be a thin green layer, which will be heated (up to around 150° C.) and hardened simultaneously; the hardened green layer can be dissolved easily in some of dissolving agents. Next, the thin green layer exposed under a high-energy beam is sintered to bond together locally because of heat effect at a temperature high enough to melt the binding agent or at least one kind of ceramic powder with lower melting temperature point. The melted substance connects the solid ceramic material which has a high melting point. After solidification a complex phase is obtained, which does not dissolve in some dissolving agents.

2. Ceramic High Energy Beam Chemical Reaction: ceramic powder and a proper inorganic binder (ex. aluminum phosphate) are mixed to form slurry. The slurry is formed to be a thin green layer, which will be heated (up to around 150° C.) and hardened simultaneously; the hardened green layer can be dissolved easily in some of dissolving agents. Next, the thin green layer exposed under a high-energy beam is sintered to bond together locally at a proper temperature (above 250° C.) by inducing chemical reaction between the binding agent and the ceramic powder, and the produced reactant does not dissolve in some dissolving agents.

In addition, in order to overcome the drawbacks of the High Energy Beam Ceramic Fusion, one variant of the present invention called High Energy Beam Cermet Consolidation adds metal powder into raw material to reduce brittleness of the work piece which is manufactured according to High Energy Beam Ceramic Fusion.

The High Energy Beam Cermet Consolidation involves four steps. It includes:

(1) preparing raw materials,

(2) forming a thin green layer,

(3) scanning the thin green layer with a high-energy beam to consolidate it, and

(4) removing unscanned portion of the green layer.

At the first step, metal powder is added to the mixture of ceramic powder, inorganic agent and dissolving agent; at the third step, the temperature can be either higher or lower than the highest melting point of the ceramic powder.

The aforementioned bonding effects at proper working temperature can be categorized into three kinds; the first one is called fusion; second one is called liquid sintering; and the third one is called chemical reaction sintering. The detailed explanation is as follows:

1. Cermet High Energy Beam Fusion: the working temperature is higher than the melting point of the constituent powder which has the highest melting point, so that all raw materials in scanned portion are melted, and will be fused together; the scanned portion is not dissolved in some dissolving agents which can dissolve the mentioned unscanned green portion.

2. Cermet High Energy Beam Liquid Sintering: the working temperature is lower than the melting point of the constituent powder which has the highest melting point but is high enough to melt the binding agent or at least one kind of constituent powder with a lower melting point. Upon scanning by a high-energy beam on the green layer, the melted material will form a network structure to connect solid powder which has a higher melting point; the scanned portion is not dissolved in some dissolving agents which can dissolve the mentioned unscanned green portion.

3. Cermet High Energy Beam Chemical Reaction: the working temperature is lower than the melting point of every constituent powder. Upon scanning by a high-energy beam on the green portion, the heated powder is sintered to bond together locally at a proper temperature, which induces a chemical reaction between the binding agent and constituent powders. The scanned portion is not dissolved in some dissolving agents which can dissolve the mentioned unscanned green portion.

The aforementioned process for making 3-demensional ceramic and cermet work piece can make complex work pieces, omit the molds, reduce the manufacturing cost, and accelerate the production speed.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

Following drawing with reference numbers and exemplary embodiments is referenced for explanation purpose.

FIGS. 1(A) to 1(H) are a flow chart of the High Energy Beam Ceramic and Cermet Making Process of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers used in the drawings and the description refer to the same or similar parts.

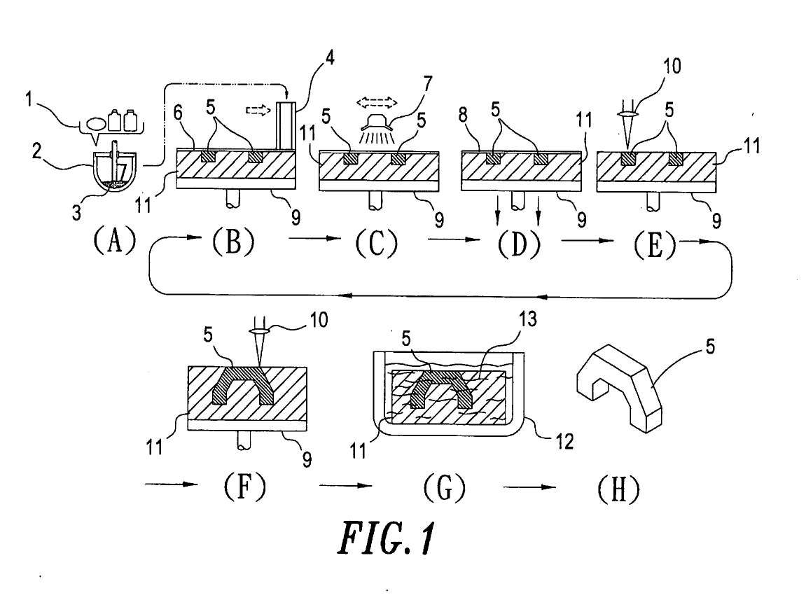

Referring to FIGS. 1(A) to 1(H), the present invention provides a process of making ceramic and cermet work piece. Following two embodiments are given respectively for ceramic work piece and cermet work piece:

1. Ceramic High Energy Beam Chemical Reaction: raw materials 1 (silicon dioxide, aluminum phosphate and dissolving agent) are mixed in a mixer 2 with proper proportion (FIG. 1(A)) to form slurry 3, where the dissolving agent can be water; the slurry 3 is poured into feeder 4 and then laid on top of the work piece 5 to form a thin green slurry layer 6 (as in FIG. 1(B)), which is heated to around 15020 C. by an infrared heater 7 (FIG. 1(C)); after the thin green slurry layer is dried and hardened, a thin green layer 8 is formed, which is dissolvable in water; the first green layer can be thicker, about 1 mm, and next thinner layer will lay on the first layer; its thickness should be reduced to about 100 μm in order to form the fine details of the work piece; thereafter, work piece 5 is lowered a distance, which is the same as the thickness (ca. 100 μm) of each added layer, with an elevator 9 (FIG. 1(D)); then the green layer 8 (FIG. 1(E))is exposed under a high-energy beam 10 at a temperature over 250° C. to induce a chemical reaction in material from the surface to a certain depth (ca. 150 μm) and the resulting reactant can not dissolve in water. Unscanned portion forms a supporting structure during the process. According to the cross sections of the desired 3-D ceramic work piece, the passage of the high-energy beam 10 is programmed and controlled by computer programs. Arbitrary shapes of 2-D cross section can be created by this way. The steps B to E are repeated one after another until the three-dimensional object is formed (FIG. 1(F)); finally, the green block 11 encompassing the desired work piece 5 is put in a container 12 (FIG. 1(G)), and dissolving agent 13 (such as water, sodium hydroxide water solution) in the container will separate scanned work piece 5 from unscanned green portion 8 to complete the process (FIG. 1(H)).

2. Cermet High Energy Beam Liquid Sintering: the process is similar to the above-mentioned one; the difference is that a low melting point metal powder is added and melted to bond high melting point ceramic powder; raw materials 1 (ceramic powder with melting point 1800° C., stainless steel powder with melting point 1300° C. and silica sol, as well as dissolving agent) are mixed in a mixer 2 (FIG. 1(A)) to form slurry 3, where the dissolving agent can be water; the slurry 3 is poured into a feeder 4 and then laid on the top of the work piece 5 to form a thin slurry layer 6 (as in FIG. 1(B)), which is heated to around 150° C. (FIG. 1(C)) by an infrared heater 7; after the thin slurry layer is dried and hardened, a thin green layer 8 is formed, which is dissolvable in sodium hydroxide water solution; the first green layer can be thicker, about 1 mm, and the next thinner layer will lay on the first layer; its thickness should be reduced to about 100 μm in order to form the fine details of the work piece; thereafter, work piece 5 is lowered a distance, which is the same as the thickness (ca. 100 μm) of each added layer, with an elevator 9 (FIG. 1(D)); then the green layer 8 (FIG. 1(E)) is exposed under a high-energy beam 10 at a temperature over 1300° C. to melt the stainless steel powder, which forms a network structure to connect the ceramic powder with high melting point. The resulted cermet phase can not dissolve in sodium hydroxide water solution. Unscanned portion 8 forms a supporting structure during the process. The passage of the high-energy beam 10 is programmed and controlled by computer programs according to the cross sections of the desired 3-D ceramic work piece. Arbitrary shapes of 2-D cross section can be created by this way. The steps B to E are repeated one after another until the three-dimensional object is formed (FIG. 1(F)); finally, the green block 11 encompassing the desired work piece 5 is put in a container 12 (FIG. 1(G)), and dissolving agent 13 (such as sodium hydroxide water solution) in the container will separate scanned work piece 5 from unscanned green portion 8 to complete the process (FIG. 1(H)).

The present invention provides a method of making ceramic work piece and cermet work piece. It has following advantages comparing to other common used methods:

1. The present invention has the same process as the High Energy Beam Ceramic Fusion, but uses different working temperatures; High Energy Beam Ceramic Fusion uses a temperature higher than the melting point of ceramic powder with highest melting point while the present invention uses temperatures below the melting point of ceramic powder with highest melting point and can be called as High Energy Beam Ceramic Sintering; the characteristic of the present invention is that there is at least one kind of ceramic powder remained in solid state due to its higher melting point, and there is less energy consumption because lower working temperatures are used; the overall result is less energy consumption, equipment costs reduction and productivity increase.

2. The present invention adds metal powder in the mixture, so that the final work piece will be less brittle than that produced by High Energy Beam Ceramic Fusion and has a characteristic between ceramic and metal.

3. The present invention is characterized in that it employs two different bonding mechanisms; an inorganic fire resistant binder bonds a thin layer of ceramic particles or metal particles to form a simple shape of hardened green layer during drying; the thin green layer is then heated by a high-energy beam to form a cross section of the desired 3-D work piece. Since the bonding mechanisms are different between the green portion and the finished ceramic or cermet work piece, the unscanned green portion can be removed by soaking in water or sodium hydroxide water solution from the work piece. Since the ceramic workpiece and cermet work piece can withstand chemical erosion much more than the green portion, sodium hydroxide water solution or potassium hydroxide water solution can be used, instead of water, to quickly weaken the bond in the green portion and to separate the work piece from the green portion.

4. The present invention uses slurry, a mixture of powder, inorganic binder and water, where the size of powder particles can be in range of mm, μm or nm; therefore, the layer thickness of the present invention is not limited by the particle size; because very thin layer can be paved, the step effect on the work piece can be reduced. On the contrary, Selective Laser Sintering (SLS) uses dry powder. When the size of powder particle is larger than 30 μm, they can be paved easily; it becomes difficult to be paved once the particle size is smaller than 20 82 m, so that the layer thickness is limited. The slurry becomes green part after it is dried and hardened. When next layer is applied, the thinner the layer, the bigger the paving force has to be applied. The strength of the present invention's hardened green portion can withstand the paving force applied for a new layer, so that a very thin layer can be accomplished. The present invention is similar to Tape Casting where commercial equipments can achieve a layer thickness of less than 5 μm so that it is possible that the present invention to achieve the same.

5. The hardened green portion of the present invention forms natural solid support to prevent upward and downward deformation of the work piece during the process; therefore, no extra support is required; the green portion can withstand the force occurred during laying each thin layer, and extreme thin layer can be made, so that accuracy can be higher than commonly used methods. For SLS, it does not need additional supporting structure and the powder support is relatively easy to be removed, but the powder can only prevent downward deformation. For SL, the liquid state material cannot do either, so that additional supporting structure has to be made; CAD modeling is then more complicated; also the supporting structures will leave marks when they are removed. The present invention is better than SLS and SL.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claim is:

1. A method for forming a ceramic work piece, comprising the steps of:
a. mixing an inorganic binder, the first dissolving agent, and ceramic powder together to form slurry;
b. forming a thin green layer on a specified surface with the slurry;
c. heating and drying the thin green layer to harden the thin green layer, because of adhesive bonding among ceramic particles by the inorganic binder, and lowering working bench at the same distance as the thickness of the green layer;
d. scanning the hardened thin green layer with a high-energy beam along a pre-determined path in order to bond the ceramic particles locally by elevating the temperature of a scanned zone to a temperature lower than the melting point of the ceramic powder which has the highest melting point;
e. repeating steps (b), (c), and (d) until a three dimensional ceramic work piece is fabricated based on a pre-determined number of thin ceramic layers that are bonded together by the high-power energy beam of the Step (d); and
f. removing a green portion, that is not scanned by the high-power energy beam, from the finished three dimensional ceramic work piece by the second dissolving agent and thus producing the ceramic work piece.

2. The method as claimed in claim 1, wherein the thin green layers are bonded because of liquid sintering when the thin green layers are scanned in the Step (d).

3. The method as claimed in claim 2, wherein the thin green layer is liquid sintered, and a melted powder is one kind of ceramic powders if a raw material thereof contains two or more ceramic ingredients.

4. The method as claimed in claim 2, wherein the thin green layer is liquid sintered; and the melted powder is the inorganic binder.

5. The method as claimed in claim 1, wherein the thin green layers are bonded because of chemical reaction bonding when the thin green layers are scanned in the Step (d).

6. The method as claimed in claim 1, wherein the ceramic powder comprises a single ceramic ingredient or a mixture of two or more ceramic ingredients.

7. The method as claimed in claim 1, wherein the inorganic binder comprises silica sol, water glass, clay, or aluminum phosphate (Al(H.sub.2 (PO.sub.4)).sub.3).

8. The method as claimed in claim 1, wherein the first dissolving agent is water.

9. The method as claimed in claim 1, wherein the second dissolving agent is water, sodium hydroxide water solution, or potassium hydroxide water solution.

10. The method as claimed in claim 1, wherein the thin green layer is paved by a feeding box.

11. The method as claimed in claim 1, wherein the thin green layer is heated by an infrared heater.

12. A method for forming a cermet work piece, comprising the steps of:
a. mixing an inorganic binder, metal powder, the first dissolving agent, and ceramic powder together to form slurry;
b. forming a thin green layer on a specified surface with the slurry;
c. heating and drying the thin green layer to harden the thin green layer because of adhesive bonding among powder particles by the inorganic binder, and lowering working bench at the same distance as the thickness of the green layer;
d. scanning the hardened thin green layer with a high-energy beam along a pre-determined path in order to bond powders locally by heat effect with a proper working temperature;
e. repeating Steps (b), (c), and (d) until a three dimensional cermet work piece is fabricated based on a pre-determined number of thin cermet layers that are bonded together by the high-power energy beam of Step (d); and
f. removing a green portion, that is not scanned by the high-power energy beam, from the finished three dimensional work piece by the second dissolving agent and thus producing the cermet work piece.

13. The method as claimed in claim 12, wherein the thin green layers are bonded because of heat fusion when the thin green layers are scanned in the Step (d).

14. The method as claimed in claim 12, wherein the thin green layers are bonded because of liquid sintering when the thin green layers are scanned in the Step (d).

15. The method as claimed in claim 14, wherein the thin green layer is liquid sintered and the melted powder is the metal powder.

16. The method as claimed in claim 14, wherein the thin green layer is liquid sintered and the melted powder is the ceramic powder.

17. The method as claimed in claim 14, wherein the thin green layer is liquid sintered and the melted powder is the inorganic binder.

18. The method as claimed in claim 12, wherein the thin green layers are bonded because of chemical reaction bonding when the thin green layers are scanned in the Step (d).

19. The method as claimed in claim 12, wherein the ceramic powder comprises a single ceramic ingredient or a mixture of two or more ingredients.

20. The method as claimed in claim 12, wherein the inorganic binder comprises silica sol, water glass, clay, or aluminum phosphate (Al(H.sub.2 (PO.sub.4)).sub.3).

21. The method as claimed in claim 12, wherein the first dissolving agent is water.

22. The method as claimed in claim 12, wherein the second dissolving agent is water, sodium hydroxide water solution, or potassium hydroxide water solution.

23. The method as claimed in claim 12, wherein the thin green layer is paved by a feeding box.

24. The method as claimed in claim 12, wherein the thin green layer is heated by an infrared heater.
